(19) United States
(12) Patent Application Publication
(10) Pub. No.: US 2026/0330330 A1
(43) Pub. Date: Oct. 22, 2026

(54) AN ENSEMBLE APPROACH TO PREDICTIVE DAMAGE ANALYTICS

(71) Applicant: RETHOUGHT INSURANCE CORPORATION, Broomfield, CO (US)

(72) Inventors: Cory Isaacson, Cheyenne, WY (US); Amit Rai, Broomfield, CO (US); Derek Lynch, Broomfield, CO (US)

(21) Appl. No.: 19/120,376

(22) PCT Filed: Oct. 11, 2023
(86) PCT No.: PCT/US2023/034978

§ 371 Date: Apr. 11, 2025

Related U.S. Application Data
(60) Provisional application No. 63/415,280, filed on Oct. 11, 2022.

(51) Int. Cl. G06N 20/20; G06N 7/08

(52) U.S. Cl. CPC G06N 20/20; G06N 7/08

(57) ABSTRACT

The present disclosure relates to systems and methods that use predictive analytics modeling, such as to identify risk profiles as it applies to potential damage to assets, persons, or other items. In one implementation, for example, an artificial intelligence/machine learning (AI) model or engine is adapted to be used as a mechanism for achieving predictive analytics from as-yet unknown adverse future events against one or a plurality of items. The AI model is adapted to evaluate a plurality of known factors for one or a set of evaluation items. The AI model is adapted to build an AI training set based on aggregate data to narrow down a plurality of clusters from the aggregate data, use AI on individual items in each cluster, compare the output across clusters to find one or more ranked elements; and identify individual items through the characteristics to provide the training set.

### CROSS-REFERENCE TO RELATED APPLICATION

The present application claims the benefit of U.S. provisional Application No. 63/415,280 entitled “An Ensemble Approach to Predictive Damage Analytics” filed on Oct. 11, 2022 (attorney reference number 016267-001PV1), which is hereby incorporated by reference in its entirety as is fully set forth herein.

### BACKGROUND

### Field

The present disclosure relates to systems and methods that use predictive analytics modeling, such as to identify risk profiles as it applies to potential damage to assets, persons, or other items.

### Background

Risk profiles may be used for any number of purposes, such as but not limited to risk mitigation, risk identification, pricing of insurance, planning for disaster recovery. Any population of similar categories of items can be subject to damage from a plurality of forces, events or occurrences. It is important in many fields to be able to forecast such potential damage, to predict or assess the physical, financial, or life impact. FIG. 1, for example, is a schematic diagram showing an example of a plurality of items that are subject to damage or other impacts due to external forces. Examples of items which are subject to damage include, but are not limited to, building structures, furniture, fine art, persons, computer systems and networks (101, 102). Such items may be acted upon by external adverse forces (103). Adverse forces can include natural catastrophic events (including excessive rainfall causing flooding, high wind forces from a tropical cyclone, tornados, tsunami, earthquakes), man-made occurrences (cyber attacks in the case of computer systems), dam or levy failures, or disease events (such as a pandemic which causes illness in persons affected). These forces then have the potential to cause damage on items affected (104).

### BRIEF SUMMARY

The present disclosure relates to systems and methods that use predictive analytics modeling, such as to identify risk profiles as it applies to potential damage to assets, persons, or other items.

In one implementation, for example, an artificial intelligence/machine learning (AI) model or engine is adapted to be used as a mechanism for achieving predictive analytics from as-yet unknown adverse future events against one or a plurality of items. The AI model is adapted to evaluate a plurality of known factors for one or a set of evaluation items. The AI model is adapted to build an AI training set based on aggregate data to narrow down a plurality of clusters from the aggregate data, use AI on individual items in each cluster, compare the output across clusters to find one or more ranked elements; and identify individual items through the characteristics to provide the training set. The training set is used to evaluate and identify all items across an entire data set resulting in a score or other metric which predicts the likelihood of an adverse or positive future impact for each individual item.

In another implementation, a plurality of stochastic probabilistic models each developed from a set of historical events, wherein each such event has a footprint that has previously occurred or is predicted to occur are provided. The stochastic probabilistic model is adapted to simulate a plurality of actual or simulated events against a plurality of items.

An artificial intelligence/machine learning (AI) model or engine is adapted to be used as a mechanism for achieving predictive analytics from as-yet unknown adverse future events against one or a plurality of items. The AI model is adapted to evaluate a plurality of known factors for one or a set of evaluation items. The AI model is adapted to build an AI training set based on aggregate data to narrow down a plurality of clusters from the aggregate data, use AI on individual items in each cluster, compare the output across clusters to find one or more ranked elements; and identify individual items through the characteristics to provide the training set.

The training set is used to evaluate and identify all items across an entire data set resulting in a score or other metric which predicts the likelihood of an adverse or positive future impact for each individual item.

In yet another implementation, A method or system for discretization of aggregate data is provided. The method or system comprises using AI to build an AI training set based on gross characters to narrow down clusters; using AI on individual items in each cluster (positive and negative clusters); comparing the output across clusters to find the ranked elements that drive a positive or negative result; and identifying individual items through the characteristics which comprises the training set.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram showing an example of a plurality of items that are subject to damage or other impacts due to external forces.

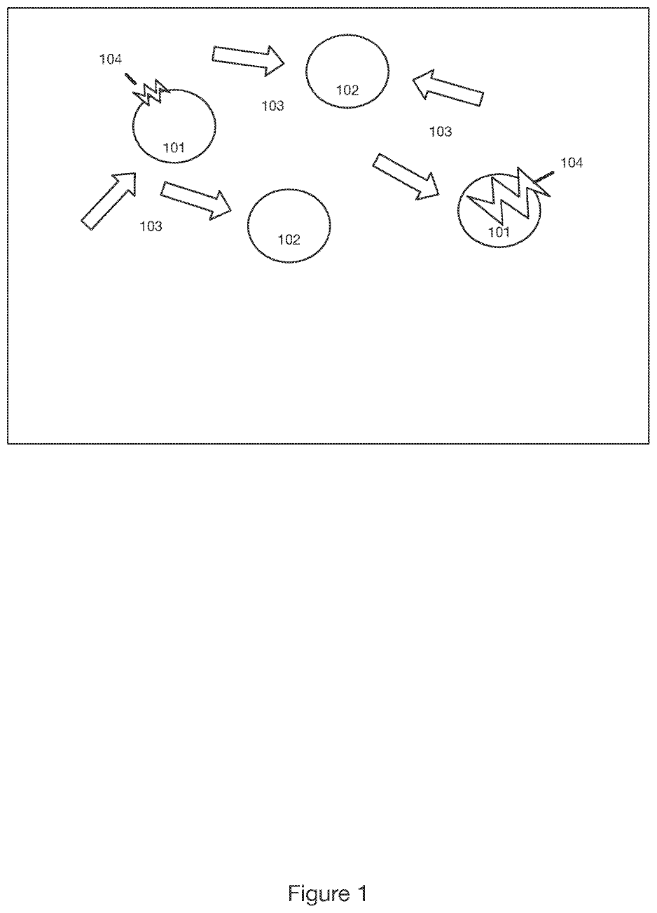

FIG. 2 is a schematic diagram showing an example of an event footprint.

FIG. 3 is a schematic diagram showing a group of historic events used to create an event catalog.

FIG. 4 is a schematic diagram showing an example of a simulation of adverse effects of one or more events against each of a plurality of items input into a model.

FIG. 5 is a schematic diagram showing an example chart 501 showing aggregate data 508 being available for each of a plurality of geographic regions or areas 502 through 507 that include a plurality of features 509 located within the plurality of geographic regions or areas.

FIG. 6 is a schematic diagram showing an example chart 601 showing how clusters identified within individual geographical regions or areas can be used to generate a valid AI training set.

FIG. 7 is a schematic diagram showing an example of an operation of identifying predictive features as shown in FIG. 6 and further building a training set from the predictive features.

FIG. 8 is a schematic diagram showing an example of an operation of applying features 802 to an entire set of items 803 to obtain scores 804 for each individual item.

FIG. 9 shows an example of a system and method for performing an analysis of predicted events based on aggregate data using an AI/machine learning engine or model.

FIG. 10 illustrates an exemplary computing system or electronic device for implementing the examples of the disclosure.

### DESCRIPTION

In one embodiment, predictive analytics modeling is used to identify one or more risk profiles for one or a plurality of items for damage from one or a plurality of forces with the potential to damage the items.

The resultant damage from forces upon items can be highly variable. For example, two buildings can be subject to the same or similar level of force from a single event, such as a tropical cyclone, and the physical resultant damage can be zero percent, 100 percent, or any value in between. The nature of the adverse forces and the ability of a given item to sustain such forces cannot be predicted in a fully precise manner, thus the problem of predictive analytics is complex with a significant level of uncertainty in the forecasted outcomes.

There are many computerized modeling approaches designed to predict the impact of damage or loss to items affected by adverse forces. These include stochastic probabilistic models, artificial intelligence or machine learning models, and many others. Each of these classes of models attempt to predict future potential damage to items based on historical events, characteristics, environmental attributes, structural features and other types of data inputs. As one example, a disease that reaches pandemic levels can affect many people adversely; however, some may become ill while others remain unaffected. Further, those that are adversely affected by illness may become so in varying degrees, from no symptoms to extreme symptoms and even death. Such models attempt to utilize historical and known inputs to predict the effects on a given population of a specific category of items, such as persons, buildings, objects or other assets, using computerized modeling based on a plurality of data inputs.

Two main categories of predictive models related to the current proposed systems and methods are stochastic probabilistic models and artificial intelligence/machine learning models.

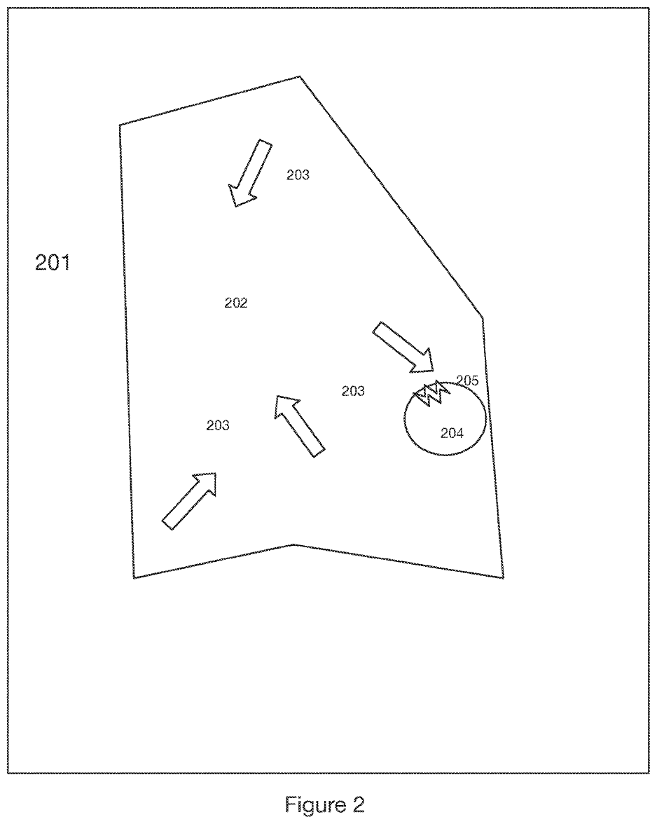

A stochastic probabilistic model typically is developed from a set of historical events, where each such event has a footprint (202) that has previously occurred. FIG. 2 is a schematic diagram showing an example of an event footprint. In this example, the footprint (202) is limited in scope in some way to a portion of a more general area or universe of items within the total possible population (201). The footprint (202) can be geographic (a specific region), demographic (a specific category of persons), a class (such as types of computer networks affected by a previous attack) among others. The historical event footprint (202) has a cataloged and detailed set of forces (203) which can be translated into a severity, indicating the likelihood of adverse damage from the forces (203) to items affected by the event footprint (202). In some cases, the amount of adverse damage (205) to specific items (204) in the historical event are known, along with a plurality of various attributes pertaining to those items.

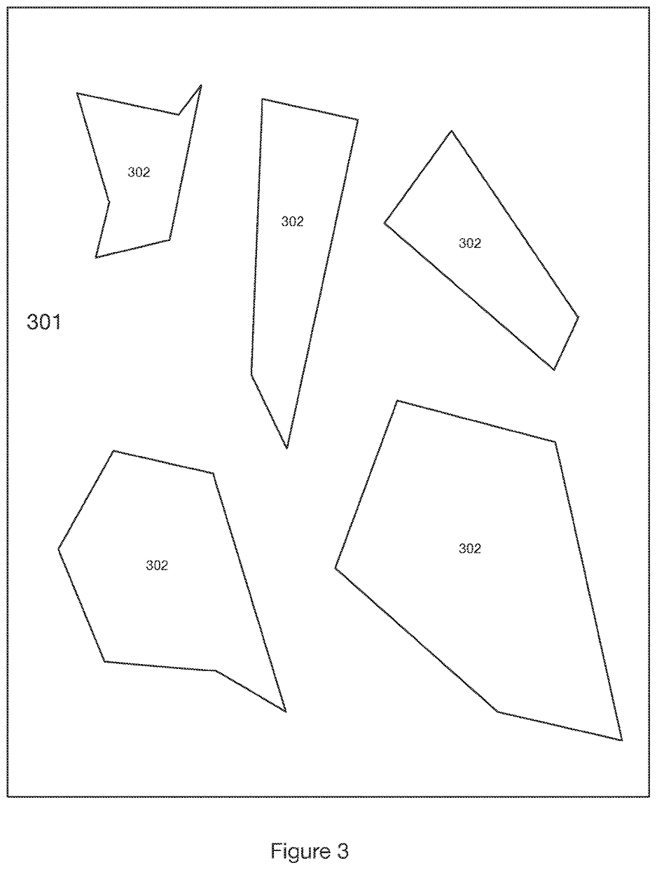

FIG. 3 is a schematic diagram showing a group of historic events used to create an event catalog. In this example, a study of historic event footprints (202) and their damage impacts are used to create an event catalog (301), or stochastic collection of events (302) based on various data inputs, influenced by judgements, experience and expertise of a modeler, the person or persons creating the model. Typically, the created events are based on historic actual events, with applicable variations. For example, in a catastrophic event which affects buildings, the variations in created events may be geographic with shifts in the footprint location of the event. The created events may also vary in severity, or any number of other factors according to the design of the model. Each created event in the catalog can include a set of variable parameters, including the geographic location of the event, degree and vector of given forces, potential frequency of such an event, and the force direction or severity. The stochastic event catalog groups the actual historic and/or created events into quasi-random pattern for use in future simulations of damage against one or a plurality of items submitted to the model. These items may be adversely affected by such events in the future and the purpose of the model is to predict or estimate potential outcomes. This is the fundamental predictive mechanism and purpose of stochastic models.

The event catalog can be organized by a set of simulation periods, with each simulation period containing one or a plurality of events from the catalog. The organization by simulation period allows each such simulation period to be run against one or more items submitted to the model for assessment. The model developer may select a standardized number of simulation periods for a model, for example 10,000 or 100,000 simulation periods. The simulation periods typically represent a randomized exemplary year or other time period that could occur, potentially affecting one or a plurality of items submitted to the model. Each simulation period is used in a sampling process (described below). The number of simulation periods relates directly to the analytic computations performed on sample damage values from the model. The number of simulation periods can then be subsequently fed into analytics statistics, to forecast the probability or likelihood of damage to the single or plurality of items. An example of such output from a stochastic model is the probability of the damage estimated. This type of output is often termed a return period, or the probabilistic estimate of how likely the predicted damage is in any given year, such as 1 in 100, a 1 percent chance of the damage estimate, or 1 in 1000, a 0.1 percent chance of damage in any given actual year.

The next phase in a stochastic probabilistic model is to simulate damage on a new, as-yet unknown set of items that are input into the model. Each item input into the model has a plurality of attributes or features that may make the item more prone or less prone to damage from an event. In the field of disease these attributes may relate to prior conditions of an individual person, such as age, co-morbidities, physical condition or other factors. In the field of predicting damage to buildings from catastrophic events, the attributes generally include the location of the structure, its construction methodology, building height, the type and value of contents within the building and many others. The output of an event simulation is generally a set of curve parameters, indicating the probability of damage to an item between 0 and 1 (zero percent to 100 percent).

Such a model typically contains a damage function or algorithm to estimate potential damage to an item from any given event based on the item's attributes or features. The event, potentially along with other events, may be contained in a simulation period. For example, a building constructed from concrete and steel can sustain higher forces from a tropical cyclone as compared to one constructed from wood frame. Continuing with the example, higher floors may be subject to higher wind speeds, exposing windows and contents to damage potentially in a disproportionate manner as compared to the rest of the structure. Persons with prior conditions, such as high blood pressure or constricted arteries may be more susceptible to a given disease. As another example, fine art pieces or mechanical equipment are less susceptible to damage when present on a higher floor or level within a building when considering flood waters as the source of damage, providing the subject building can withstand the forces from the flood without collapse. Any combination of a plurality of attributes regarding the structure, person, or environment may be considered when estimating damage from a given event. Further, some attributes can result in more or less impact when they are considered. All of these physical and environmental factors contribute to a complex simulation and analysis that can then be applied to the prediction of real-world future events.

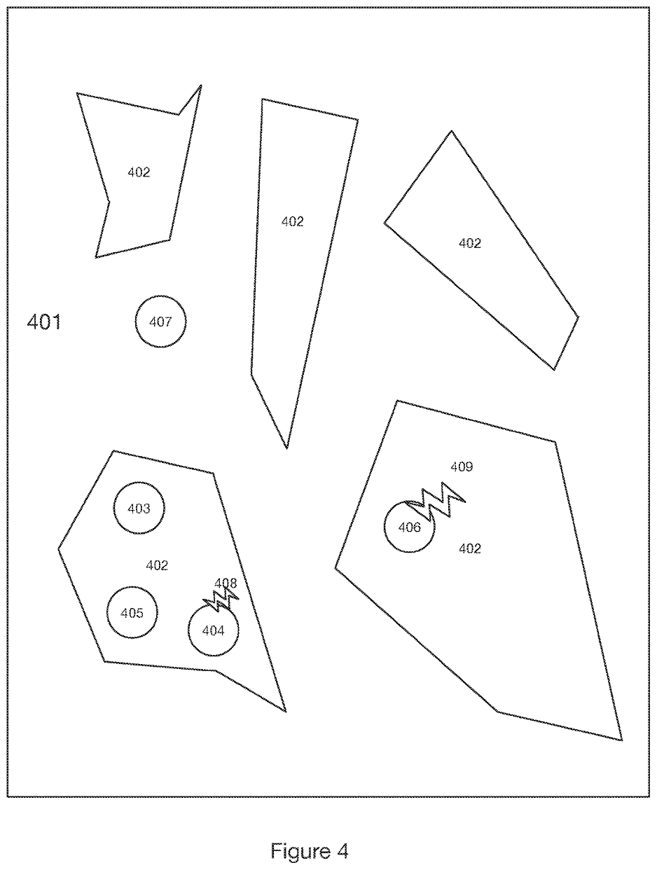

The model then simulates the adverse effect of each of the events in the event catalog (401) against each of the items input into the model (403, 404, 405, 406, 407). FIG. 4 is a schematic diagram showing an example of a simulation of adverse effects of one or more events against each of a plurality of items input into a model. One or more items may be in one or more of the event footprints (402), and if so the potential for a simulated damage result exists. Note that some items (407) may not lie within any of the event footprints (402) in the catalog (401); in such a case no damage simulation is possible and the predicted damage to the item from such an event footprint will always be zero, or zero percent. Damage can only be simulated against items (403, 405, 406) that fall within one or more event footprints (402).

Because any given event only offers the probabilistic possibility of damaging an item (403, 405, 406) within its footprint (402), further uncertainty processing may be performed by the model. For each event footprint (402) that has a given severity and the set of attributes or features of each or a set of items are utilized to predict its susceptibility to damage for any given item.

The model then produces output, often in the form of a probabilistic curve of potential damage to an item or set of items, from zero (no damage) to 1 (complete damage). In some stochastic probabilistic models this curve is then processed with a randomized sampling phase, selecting discrete potential damage points and values from sampled points along the curve. This output can be subsequently used in analytics of the plurality of discrete points to formulate useful views of the potential damage resulting from model simulation and sampling processes.

The number samples per event curve may effectively multiply the number of discrete damage output values from the model. For example, a model that utilizes a 100,000-simulation period set may generate 10 or 100 samples for each event that generates potential damage. Therefore, the effective number of simulation periods in the sampled output can be 1,000,000 or 10,000,000 simulation periods respectively.

The output of the simulation and damage curve sampling from such a model when using this sampling approach is a set or plurality of discrete damage points, usually expressed as a percentage of damage to each subject item or items being assessed. As described above, the discrete damage values or generated by the model from randomized points along the damage curve from an event adversely affecting one or a plurality of items. There can be thousands or even millions of such damage points produced in the sampled damage value result.

Various statistical calculations can then be performed on this set of damage points, showing the potential damage at various return periods (percentages of probability), or an average annual damage figure, which is the average of all simulated damage points divided by the number of simulation periods. These analytic metrics can be used for a variety of purposes and provide a view of potential risk of damage to the item or plurality of items being evaluated. In particular, the average annual damage can be used to calculate a financial cost for repair of the damage, or a numerical score or other statistical derivation used as the output of the model. Thus, a given catastrophe model run on a set of items as its input can simulate damage and useful analytics metrics based on these input items. The model output can represent the potential damage to one or a plurality of items submitted for processing.

Different stochastic probabilistic models vary widely in their results, even when the same set of inputs are used. This can be due to varying historical events or interpretations of those events, various methods for the creation of new simulated events, the amount of input data available when developing the model, or varying severity or interpretation of the impact of event severity. These are just some of the variations possible between given models, even when their intended purpose and category of items, item attributes and event classes are the similar. Thus, the simulated damage against input items and the resultant output can vary widely. This variance reduces the usefulness of models, making it more challenging for users of the models to interpret meaningful results.

In summary, stochastic probabilistic models utilize a top-down approach in their analysis, simulating a plurality of events against a plurality of items. Such models are useful in quantifying the risk into meaningful metrics, such as the extent of potential illness or percentage of damage to buildings or other physical assets which can be valued.

Artificial intelligence/machine learning (AI) can be used as an alternate mechanism for achieving predictive analytics from as-yet unknown adverse future events against one or a plurality of items. In contrast to stochastic probabilistic models, AI relies on a bottom-up approach, considering all that is known about one or a set of items, and comparing through a variety of pattern recognition and learning algorithms to predict potential future damage or outcomes.

It is important to note that stochastic models are very strong when it comes to assessing the quantitative potential damage percent of a given item, using the approach modeled above. This is accomplished through decades of development and refinements in these models. The AI approach is qualitative in nature; it can predict the potential of loss in an alternate manner but is not as useful in quantifying predicted damage. Stochastic models are more useful in the quantification of potential damage, whereas AI models can show the likelihood of damage or lack thereof to a given item.

In one embodiment, a system or method provided utilizes a balance of both stochastic and AI model approaches to provide predictive analytics from events to a set of items, yielding improved output and interpretation than either method in isolation.

An AI approach first identifies a set of items with known outcomes from various events, usually historical events. The items have a true (positive) or false (negative) damage from the known events. This set of items is known as the AI training set. Further, a training set may include identified severity of the damage from various events. As an example, considering a disease in a pandemic, identifying a set of persons who either did get ill, or who did not get ill from the disease would be the training result. After this, further gradations of damage can be applied, such as how severe the damage was to the adversely affected persons.

Rather than a model developer building a damage function or algorithm, an AI model “learns” through a multitude of simulations and pattern recognition, which can number in the millions, billions or even trillions. The simulations are first processed against the training set and using all known attributes or features for each item. The computer “learns” from the simulations and patterns identified, without direction from the model developer. The learnings from the training set generates a derived set of attributes which are more or less likely to result in damage, without a model developer feeding such parameters to the model.

As an example, consider a set of buildings as a training set, where the damage or lack thereof has been identified, creating a training data set of buildings that sustained damage, or positive items and those that did not sustain damage, the negative set of items. In this example, the training data set must be known in advance as to actual damage or lack thereof in order for the AI model to “learn” from the training set. Many attributes of each item in the training set are considered. If buildings are the subject of the AI model, the attributes or features could be geo-location, construction type, building height, and potentially dozens or hundreds of others. Assumptions about which attributes may contribute to damage or lack thereof are not provided to the model; rather the AI model will process a multitude of simulations against the attributes of each item in the training set, and then looking for patterns across a set of items to determine which attributes are more contributive or less contributive to damage. These learnings from the model processing can then be used to interpret the likelihood of damage, based on the known positive or negative inputs provided in the training set.

As stated above, the training set of items is evaluated against a multitude of characteristics or attributes which can be known regarding each item. Such attributes can also relate to the environment of a given item. Continuing with the pandemic example, the prior conditions, heart health, nutritional history, genetic history, socio-economic status and many other factors could be considered as features of each item or person in the training set. The known illness or lack thereof of each item or person in the training set must be provided to the model which can then “learn” which attributes or features drive the likelihood of illness, without direction from the modeler. Thus the validity, completeness and accuracy of the training set of items is key to the success and usefulness of the AI model approach.

When applying this approach to buildings adversely damaged by extreme weather events, the training set would include a set of known buildings that were or were not adversely damaged from the types of events under consideration, for example flooding from rainfall. The extent of damage may be considered for each positive, or damaged building as the result of an adverse event. Conversely the training set includes buildings that did not sustain damage, or the negative set of items. Many attributes about the buildings would be collected, such as geographic location, topography, meteorological history, type of construction, building height, number of stories, or type of use.

By running a multitude, potentially millions, billions or trillions of algorithmic matches across all attributes via AI, patterns of attributes can emerge or “learned” as to which attributes are contributive to the likelihood of damage, along with their relative importance of each attribute in determining such damage. Conversely features or attributes or lack thereof can be identified which indicate resilience to damage. In this manner the AI model generates a new set of features or attributes that are useful in predicting damage or lack thereof. The model can further provide develop a “learned” weighting to specific attributes as compared to other attributes; in other words which attributes are most predictive of damage or lack thereof to specific items in the training set. Such attributes or patterns are compared by the AI engine across many attributes in the training set. This approach is termed artificial intelligence, or machine learning, because the computerized algorithm itself draws the correlations between attributes and their associated patterns, including the statistical weighting or importance of a given set of attributes or features. The resultant output of a plurality of attributes or features generated by the model provides new insights into the drivers of damage or lack thereof.

In this way patterns and associations that would not be possible via human analysis alone are recognized and uncovered. AI relies on the correlation of known attributes among a set of known positive/negative items to determine the likelihood of damage, generating a set of specific, correlated and weighted attributes and features as its output. This is an opposing approach to stochastic probabilistic models which focus on studying events in detail, and then determining through random simulations of such events against a set of items that may be damaged generating a set of probabilistic metrics.

As stated earlier, a valid training data set comprising a plurality of positive and negative individual items along with a set of known attributes or features for each item is required for an AI model to function and “learn” which features are the drivers of damage. The AI model (or models) process a plurality of pattern matches on known attributes or features of each item, thus “learning” or determining those attributes or features that contribute to damage or the lack thereof.

Once an AI model is trained on a valid training data set of sufficient size and validity, along with a set of identifiable features or attributes of each item in the training set, it can be used to predict the likelihood of damage on new items fed to the model, those hitherto unknown to the model. This is now done by applying the identified set of features or attributes “learned” from the training set to these new items. All that is required for the new items is identification of the features or attributes of the items, and from those the AI model predicts the likelihood of damage or lack thereof based on its prior training.

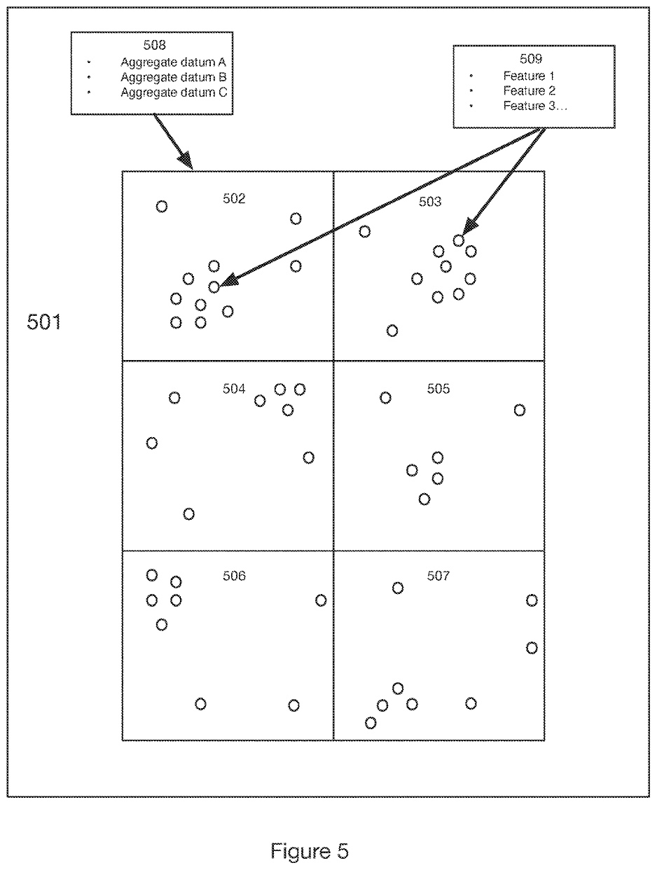

A common impediment to the AI approach is that a valid training set of a sufficient quantity of individual items and validity of positive and negative occurrences is unavailable. In many cases however, valid aggregate or summarized data is available (502, 508), representing an unidentified set of individual items. FIG. 5 is a schematic diagram showing an example chart 501 showing aggregate data 508 being available for each of a plurality of geographic regions or areas 502 through 507 that include a plurality of features 509 located within the plurality of geographic regions or areas.

Continuing with our disease example, it is often possible to obtain aggregate data on the cumulative statistics and damage resulting from an outbreak of disease. In such cases, only aggregate data is provided, to preserve the anonymity of individual persons adversely affected by the disease. Similarly, in a property example, data sources can exist that provide the aggregate damage percent, number of buildings damaged, financial cost and other summary data by a geographical region or area (508), without identifying individual buildings or properties.

As stated earlier, the AI approach depends on a training set composed of a sufficient quantity of a plurality of individual items, each item identified as positive (adversely affected) or negative (not adversely affected) in the set. A set of aggregate data does not satisfy this requirement.

It is possible to identify attributes or features of individual items from a variety of sources (509), but such data has no correlation to damage or lack thereof from historical events. Further, in one instantiation the individual items within the aggregate data are identified, along with their attributes or features (509). Therefore, attributes or features of individual items which are not correlated to damage cannot be used as a valid training set. Identification of individual items which are positive (damaged) or negative (not damaged) must be determined.

Continuing with the property example, a geographic region (502, 503 . . . 507) is identified in an available data set, indicating the total damage or lack thereof across all items in the area specified over a period of time. It is possible to identify all properties or items within each region, but it is not known as to which items experienced damage, or lack thereof. The only thing known is the cumulative damage or lack thereof across the entire geographic area and the total set of properties within the region.

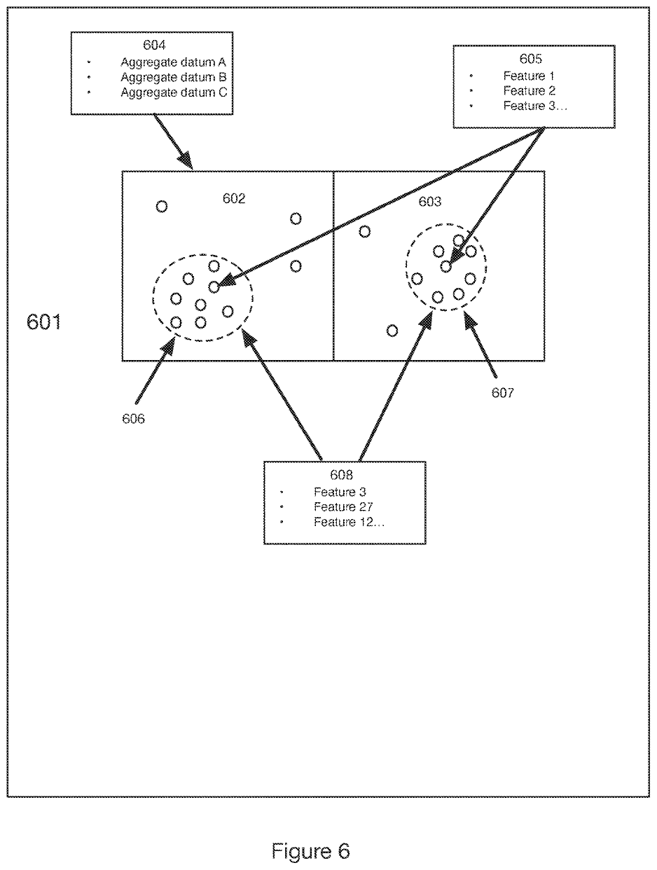

FIG. 6 is a schematic diagram showing an example chart 601 showing how clusters identified within individual geographical regions or areas can be used to generate a valid AI training set. In one instantiation an approach is utilized to generate a set of items that represent a probable cluster (606) of positive or negative items from the aggregate, summarized data. For example, this can be performed by examining various factors such as the density of properties within the geographic region, as a subset of the entire region described by the aggregate data. Similarly in a disease example, population densities is used to identify such a cluster of probable positive or negative persons or items. Other factors considered could be the value of such properties, or the proximity to the coast or water in the case of assessing tropical cyclone of flood risk; other prominent factors which relate to the source of potential damage may be assessed as well. Using these initial assumptions a set of clusters that contain a preponderance of positive or damaged items, and conversely the negative or lack of damaged items. Having generated the clusters which likely contain the preponderance of damaged or undamaged items, the aggregate data is then applied as percentages to each cluster. In this exemplary approach, such a preliminary analysis that would be used to identify a plurality of clusters (606, 607) of properties within each set of items which has been described by aggregate summary statistics or data. Each cluster (606, 607) is composed of a plurality or set of items or properties included in the aggregate statistics. At this point the requirements of a workable training set of individual items that are positive or negative are not yet known, only a plurality of clusters of items that have a high likelihood of past sustained damage, or lack thereof. In other words, which individual items within a given cluster that sustained damage or lack thereof is not known.

To further describe this property example, a specific geographic area (602), such as 100 square kilometers, is described in the aggregate data set. The geographic area contains a plurality of buildings, for example 10,000 individual buildings. The aggregate data indicates that a total of 500 buildings (5%) were damaged over a specified time period, with a total cost of the damage of $10,000,000. Using factors such as geographic building density or other prominent data elements which can be known about the plurality of buildings in the specific geographic area (602), a cluster (606, 607) of a plurality of buildings, perhaps 100 to 1000 buildings from aggregate set can be identified to which the preponderance of damage or lack of damage likely occurred. Conversely the approach can be applied to geographic areas which in aggregate sustained little or no damage historically, identifying clusters of a plurality of buildings which were likely undamaged by past events. In this instantiation the generation of clusters of items which contain a preponderance of items likely affected or not affected by the aggregate data known is key to the approach described. In our building example using aggregate data and cluster identification, as many as 500,000 such clusters were generated from the initial attributes used to narrow the cluster area.

At this point the clusters of interest are identified, and the aggregate percentages of damage are applied to the specific cluster. Further, each item within each is identified, and the attributes and features of each item are also known, as collected from a variety of data sources pertaining to the items. The individual items within the cluster which sustained damage or did not sustain damage are still unknown, thus new data must be generated to meet the requirements of a useful training data set.

Now that clusters of buildings (606, 607) have been identified, AI can be applied to build a valid training data set for the AI model. In one instantiation, AI can be performed on each item within a cluster (606), using a plurality of attributes or features. For example, 100 or more features can be evaluated. AI processing on an individual cluster (606) still cannot identify which specific buildings sustained damage (positive) or likely did not sustain damage (negative). The example can be continued to perform a plurality of AI methods against a plurality of clusters, each cluster derived from a known aggregate data set. In the property example described, this may require as many of 500,000 clusters to be so evaluated.

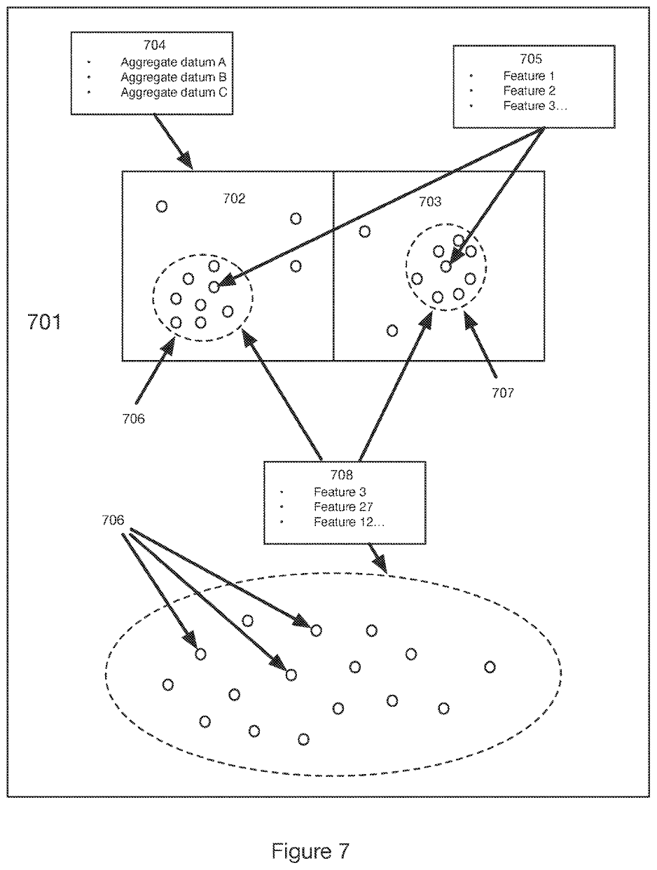

FIG. 7, for example, is a schematic diagram showing an operation 701 of identifying predictive features as shown in FIG. 6 and further building a training set from the predictive features. As shown in FIG. 7, aggregate datums 704 are providing in the aggregate data source corresponding to one or more geographic regions or areas 702, 703, and one or more clusters 706, 707 are identified within one or more of the geographic regions or areas 702, 703 as largely likely positive or negative collections based on the datums provided and other filters. Predictive features 708 are identified from the clusters across the entire aggregate data set 706, 707 within the geographic region or area 702, 703. A training set of individual items 706 is built from the predictive features 708 with assignment of likely positive or negative cases using these features. This process requires extensive comparison of clusters and the items contained therein across the set of clusters.

The AI model can then be used to compare patterns of derived attributes of each individual item within a cluster, then subsequently comparing the generated patterns to all other clusters. This requires potentially trillions of AI model iterations to perform the pattern matching and identification, utilizing many AI model approaches and 100 or more attributes or features, where such features are known about each individual item within each cluster. Each feature or attribute can be further weighted and prioritized for its importance as contributory to damage. The data generated from this step is a plurality of features or attributes correlated across all clusters so identified. In this instantiation the set of features or attributes are prioritized and weighted to indicate damage or the lack thereof.

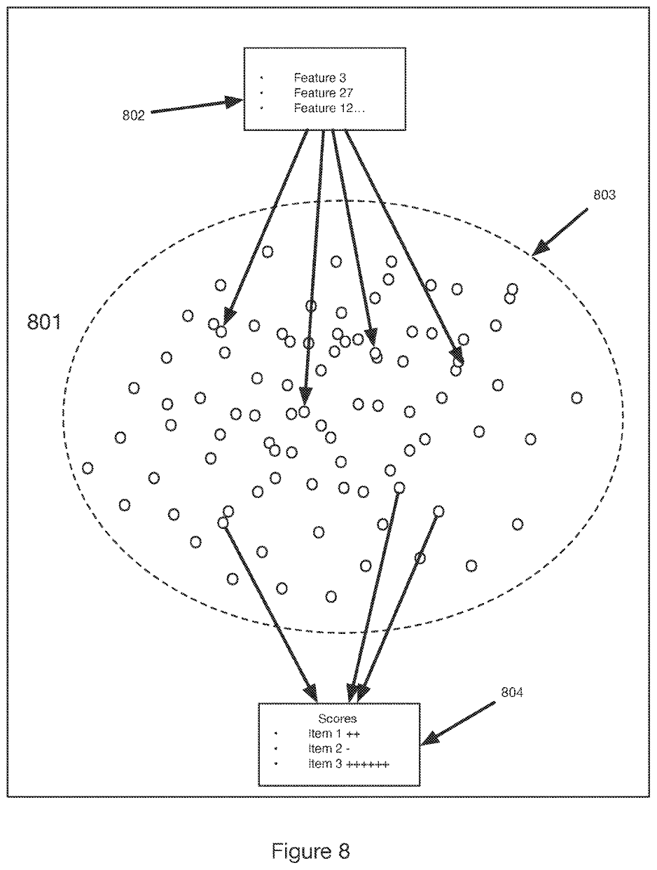

FIG. 8, for example, is a schematic diagram showing an operation 801 of applying features 802 to an entire set of items 803 to obtain scores 804 for each individual item. Thus the result is a prediction for each item as to the likelihood of a future event impacting a given item.

Continuing with the property example for tropical cyclone risk it may be found that ground elevation is the top driving feature for predicting damage, with a weighting of perhaps 12% importance. Following this could be building height, ranked second at 10% importance in predicting the likelihood of damage. After this all other attributes could be ranked, with an attribute such as the surfacing of the building being identified by the AI model as an unimportant or low-ranking attribute.

The data generated from this operation is a reduced set of AI approaches and a reduced set of features and attributes (608) which are predictive of damage or lack thereof. These features and attributes are prioritized and weighted as described above, ranking their contributory effect to the likelihood of loss.

The reduced set of AI approaches and identified features (608) and attributes is then used to evaluate each building or item in each identified cluster for the entire data set described by the aggregate data. Each set of likely positive or negative items in each cluster is compared or correlated by the AI model to the likely set of positive or negative items from each other cluster. This correlation or comparison is used to generate a set of the individual items that sustained damage or did not sustain damage. The result is a generated valid training set that has been generated by the AI model. This training set, the ranked items and features that drive damage or lack thereof can then be applied in future evaluations to items outside of the identified clusters, providing a useful prediction of the likelihood of damage.

By applying the ranked and weighted attributes and features to each item in each cluster, a composite score for each item may be generated that can be used as an indicator of the likelihood of damage or lack thereof. This score is generated for each individual item or building across the plurality of buildings identified in all clusters in the data set (608). These generated individual buildings and their scores then comprise a valid training set for AI, and at the same time produce the output of the training: the prioritized, weighted features, attributes (608) and AI model approaches that predict damage on any individual item, regardless of specificity.

In this example, the approach can be validated by checking the model results against real-world events that cause damage. Another method used to validate the model can be performed by reserving and isolating a substantial percentage of item clusters from the initial training data set, running the AI model against the items in this plurality of items, and using the AI model to predict the aggregate statistics provided by the original data source. The reserved segment of the training set is completely independent of the segment of the training set used to train each model; its purpose is to test the validity of a given modeling approach. The predictive aggregate statistics are then compared to the original data source, the percentage of such validation is termed the area under curve in AI terms, or the success of the AI model in predicting future susceptibility to damage or lack thereof across as yet unknown items to be evaluated.

To identify the correlations or relationships across attributes amongst a set of individual items, many AI modeling approaches are initially used. The results of any given AI modeling approach can be compared for its ability to predict future damage by testing it against a reserved segment of items from the training set. Through simulations and pattern recognition across numerous items, item attributes, model approaches, and through testing the output of each model approach against the reserved segment of the training set, a subset of model approaches is generated be identified which more closely predict the known outcomes in the training set.

Thus, it may be said that an AI model looks at individual items and their characteristics, or the characteristics of the environment for each item based on a known training set (bottom-up); a stochastic probabilistic model uses a catalog of events to do a similar job but from a different point of view and approach (top-down).

Once the AI training set and all available, known attributes have been pattern matched and processed via a plurality of modeling approaches, the resultant output is a set of characteristics of items (608), along with specific AI simulation approaches which are known to predict the damage among the training set of items. This AI output generated from model training can then be applied to new as-yet previously unevaluated items, used to determine based on their attributes alone whether or not they are susceptible to damage from similar types of events by applying the learnings from the training set.

The training set is critical in importance to the success of an AI modeling approach. The example approach discussed here provides a useful AI training set, derived from aggregate summarized data on generalized data sets and uncorrelated known attributes and features of individual items within those generalized data sets as the only inputs. The AI processing itself determines the predictive, weighted features and attributes and resultant scoring of items through the approach described.

The AI approach starts with each item and builds to a learned conclusion. The stochastic probabilistic approach works from a foundation of events of specified intensity and then applies simulations against new sets of items to predict future potential damage. As stated above, stochastic probabilistic models are good predictors of quantitative potential damage, yet models vary widely as they are dependent on the quality and approach used in creating the underlying event set. The AI approach provides a strong qualitative measure of the likelihood of damage to an individual item.

Both approaches for predictive analytics of damage to one or a plurality of items in a given class or category are useful but can deliver much different results due to their fundamental differences in approach. There are certain advantages to each type of predictive model. The stochastic, probabilistic model is useful at predicting the adverse damage against a broad set of input items. Further such a model is also useful in predicting the extent or a quantitative prediction of damage, based on the various stochastic and randomized methods used to determine potential damage. Such a model can also assess potential damage to a variety of characteristics or segments of a given item, for example the contents contained within a building. This approach can be used in predicting the potential damage across an entire set of items, while it is less accurate or predictive of damage to any single item in the input set.

The strength of the AI approach is based on its ability to evaluate many attributes and features of any single item, comparing that to a known set of training set. With enough simulations and pattern matching the output and correlation from the AI approach is very useful in predicting the likelihood of or susceptibility to damage for any individual item. However, the AI approach cannot easily predict the extent of damage as well as the stochastic probabilistic approach, or return periods (probabilities) of damage, nor can it estimate the potential damage to an entire set of items as when compared to the stochastic probabilistic approach.

The proposed method presented here is to balance the usefulness of both approaches, yielding a better and more precise predictive result for the consumer of the model when applied to determining potential future damage from adverse events when a given set of items is being evaluated or assessed. The approach takes into consideration the strengths and drawbacks of both probabilistic stochastic models and AI, resulting in output that provides a more comprehensive, multi-view prediction of future damage outcomes.

In the examples and instantiations presented we illustrate how a plurality of stochastic models can be intelligently weighted from the scoring or other output from an AI approach, in a converged view of a plurality of stochastic model outputs that more closely approximates potential damage. This is done by comparing the output results of each model within the plurality of models and weighting the results based on a score or other metric developed by the AI approach.

Stochastic probabilistic models developed by different modelers can vary widely in their results. For example, in assessing property risk, the estimate of loss can vary between any two models by ten times or more for the same geographic point or building being assessed. These differences occur due to the variety of events included in each model's event catalog (FIG. 4), the method or methods used to develop those events, availability of historical data, the expertise of the modeler, availability of resources to the modeler, the focus and objectives of the model, the assigned frequency of a given event in the catalog, and many other factors. Further, given the vast quantity of potential items in any universe for a given class, it is infeasible for any single model to cover all potential items adequately. When considering potential damage to property or buildings, for example, one model may deliver more accurate data and assessment in one geographic region or type of event, compared to another which may focus on differing regions or event types. Each model will have gaps in its coverage given the scope and amount of data available or processed in constructing the event catalog. However, despite these differences, the stochastic approach yields a damage assessment with the strengths of the approach described earlier. Each given stochastic model can be considered to output a view or opinion of risk given the approach taken to develop its event catalog.

To balance the output of variances in the view of risk, and to consider the best assessment capabilities, in one instantiation the proposed method utilizes a plurality of at least two stochastic models when predicting potential damage. This plurality of stochastic models is termed the model set. The output and potential damage generated by each individual model is then considered for assessment, and the models are compared to one another for validity and accuracy.

In some cases, the event-based models will be in close agreement in the view of risk presented; this is typically in specific areas or causes of potential damage to items where the field has matured and the community of model developers adopt a common underlying data source for development of events. One example of a commonly used data source for such potential damage relates to a tropical cyclone along the eastern our gulf coast of the US. The underlying data source for such models is often the Sea, Lake and Overland Surges from Hurricanes (SLOSH) model provided by the US National Weather Service. Given one or more models that base their events on the SLOSH model, the results can be very similar.

In other cases, any two stochastic models may differ widely in their assessment of potential damage to a given item, particularly in newer types of assessments which lack voluminous or common data sets for development of their event sets. Examples of newer, less-proven or standardized sources of damage are terrorism or cyber risk. These fields have less data available and cannot benefit from a common data set such as the SLOSH model; thus, independent model developers may widely differ in their development of event catalogs, contributing to wide variance in damage predictions.

As stated above, to accommodate for these variations, the proposed method in one instantiation considers a plurality of stochastic models when predicting potential damage to one or a plurality of items, recognizing the differences in assessment from each model. This is done at the sample output of each stochastic model, a voluminous amount of data that takes advanced computer processing to evaluate.

It is important to consider that the use of 100,000 simulation periods in a given model in the model set can yield many more samples, effectively increasing the number of simulation periods. Each simulation period contains one or more events from the event catalog, each with its own curve parameters to forecast potential damage from 0 to 1 as described above. In turn each event curve may be sampled to produce individual discrete loss values. Based on the event hit rate upon items within the set being assessed, there can be more or fewer events which produce potential damage. Each of the events which do produce potential loss are then sampled. For example, a given model may produce 100 individual samples for each simulation period, in effect yielding a 10,000,000-simulation period output. This sampling increases the granularity of the data and smooths out the final analytics for a more detailed picture of predictive loss.

In one implementation the method combines the sampled, discrete damage value results of each model in the model set. If one model in the model set utilizes a 100,000-simulation year event catalog with 100 samples, then the potential for 10,000,000 discrete samples may be output. Another model may use a smaller number of simulation years, for example a 20,000-year event catalog with 10 events for a 200,000-year output. The objective is to combine the results of these varying models into a single assessment.

To assess and evaluate the model set it is required to normalize the model output to a standardized number of simulation years. Continuing with this implementation, 10,000,000 simulation years may be selected as the standardized value. The output from model with the smaller number of simulation periods must be standardized such that the output from the model can be combined with other models in the model set.

One approach for achieving this normalization of periods involves replication of sample damage values from the model with the smaller set of simulation periods to match the standardized number of simulation periods. Another method is to rely on the curve parameters from a given model and to sample the curve with a number of samples required to match that of the standardized simulation period output. The data processed is more voluminous in this implementation, but a yield of higher accuracy in predicting damage can be realized.

In this instantiation the method then assigns a weighting to each discrete stochastic sample damage output from each model in the model set. By performing the weighting at the detail sample data level, more control over the assessment of differences is realized. These weighted samples are then combined by standardizing the simulation period size across the model set.

The implementation described can then combine the sampled output from each model in the model set using a variety of methods. One such method sorts the sampled output of each model in the set from highest to lowest and then adds the sorted sets together, resulting in an converged set of sampled losses matching the standardized simulation period output. Another method can be the concatenating of the sample loss values from each model into a larger set.

This is the output of the entire process, applying the AI generated score or other data for each individual item to the sampled stochastic model output for each model, and then combining the sampled output into a single new result of converged stochastic output. This is a new stochastic data output set containing a converged view as influenced by the AI approach. This output is used for analytics processing in the same manner of computation as that used for any individual stochastic model.

With the standardized number of simulation periods, analytics calculations may be performed on the combined, standardized samples from the plurality of models in the model set, resulting in a more accurate representation of predictive damage.

As described earlier, the output of the ensemble approach can be used for many purposes. One example is a risk management for a corporation with many properties or other tangible assets deployed in various geographic locations. This results in a significant need to predict the risk so it can be managed appropriately. Disasters of many types, including supply chain shortages, natural disasters, even economic disasters play a role. The risk is quantified so it can be estimated, with full financial and operational plans developed based on the analytics described in the embodiments presented. Using accurate risk prediction and quantification, alternate business operational plans and financial reserves can be allocated to ensure business or operational continuity. Then when a real-life disaster does come about, the risk managers of such an entity are equipped to deal with it by implementing such plans with foreknowledge of the likelihood of damage to given assets and the costs associated therewith. This preparation may include alternate facilities, backup systems in the event of a cyber-attack, alternate suppliers to overcome supply chain shortages, insurance coverage and financial projections as to the cost of any given disaster.

Further, using the output of the model approach presented, assets and systems can be proofed to make them more resilient to damage exposure. As an example, this can include engineering improvements to buildings to lessen the impact from various types of events. Similarly, using risk prediction tools can enable computer systems and processes to reduce the potential for cyber-attack or to proof systems against such an attack.

Another example is governmental organizations at the national, state or community level. Such organizations will want to plan improvements through legislation, tax assessments or investment to improve resilience to items or plurality of items within their jurisdiction. A local community for example may implement a project to add flood barriers, seawalls, or levies to protect a community based on foreknowledge of the potential for damage to specific properties from a flood-related disaster. The engineering and resultant cost of such improvements can be better estimated with an accurate prediction of the likelihood of such damage.

In the field of healthcare and disease management, government or healthcare officials can utilize the predictions of the model to identify the characteristics of individuals most susceptible to a given disease. This information can then be used to notify such individuals and warn and potentially protect such individuals to reduce the impact of a pandemic or other outbreak.

The processing required for the AI involves large amounts of data, computational capability, and a plurality of processors all working in parallel. In one implementation it took 6 months of processing across numerous parallel computer processes performing trillions of calculations, each running on a single “core” of a server. This implementation required trillions of computations in order to identify the clusters, compare the clusters one to another, and perform a plurality of AI approaches to the data, over 70 were tested. This trained the AI model based on the preponderance of likely positive or negative items. This resulted in identifying the clusters, identifying which AI approaches worked with the aggregate data set, and producing the list of significant item features of importance (out of many dozens of item features). These significant features were then further processed across clusters, over 100,000 such clusters in this implementation, resulting in a training set of a plurality of individual items, each identified singly as likely positive or negative. This resulted in a workable AI training data set, one that could not be created from the original aggregate data. Further processing with a large number of processes running on a plurality of cores was then required to apply the significant features to the entire data set, beyond the training items and clusters. The end result from this instantiation was a numeric score that indicated which items were more or less likely to be affected by adverse events. This result data set, and all of the interim data sets, were stored for future access to utilize the numeric score in predicting risk for this implementation. Finally, the same cluster of computer processors and processes were used to back test and validate the results, in a computational manner as well as comparing the results to real-world events. The conclusion in all cases resulted in 92%+ accuracy in the prediction accuracy of the numeric score. This large data set including the many steps of computational analysis and AI approaches would not be possible by ordinary or manual means, a continuously running cluster of processes against the input data is required, yielding the final result.

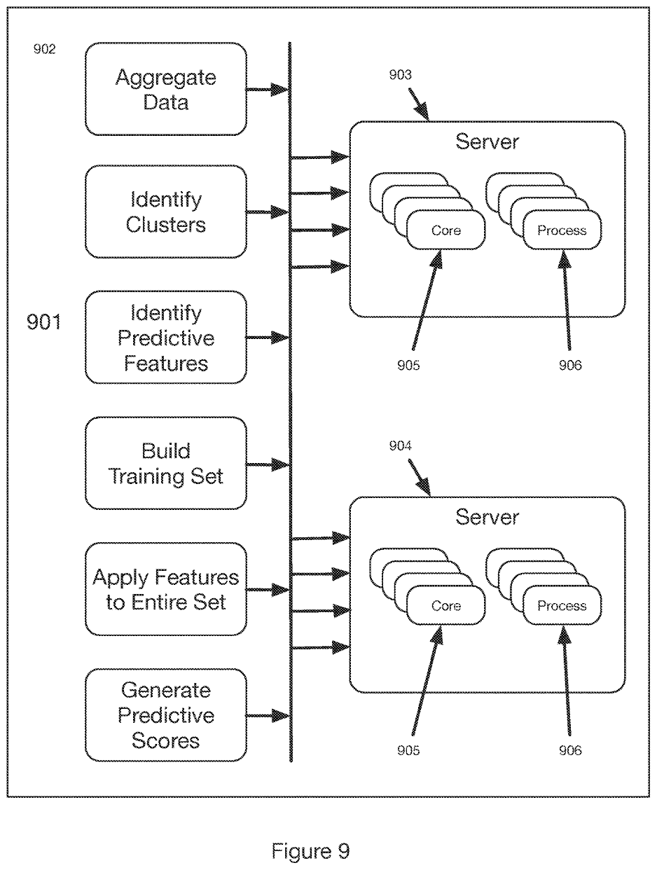

FIG. 9 shows a system and method 901 for performing an analysis of predicted events based on aggregate data using an AI/machine learning engine or model. In this embodiment, the AI/machine learning engine or model is adapted to perform a series of operations corresponding to the operations shown in FIGS. 5-8. In one operation corresponding to FIG. 5, aggregate data is available for each of a plurality of geographic regions or areas that include a plurality of features for individual items located within the plurality of geographic regions or areas. At this stage it is not possible to identify which item features contribute to the prediction of likely impact or lack of impact from a future event.

Clusters are identified within individual geographical regions or areas in another operation as shown in FIG. 6. Predictive features are identified from within the geographic regions or areas from extensive AI processing and comparison across the plurality of clusters, and are then used to generate a valid AI training set of individual items as shown in FIG. 7.

The identified features are then applied to the entire set of items and predictive scores are generated as shown in FIG. 8, wherein the scores predict the likelihood or lack thereof of the occurrence of a potential future event. Thus the entire process uses extensive and voluminous AI processing to move only aggregate datums to predicting the likelihood of impact or lack thereof for each individual item in the entire data set.

The processes/operations shown in FIGS. 5-9 are processed on one or more servers 903, 904 each comprising a plurality of cores 905 operating a plurality of processes in parallel to perform the operations of FIGS. 5-9 .

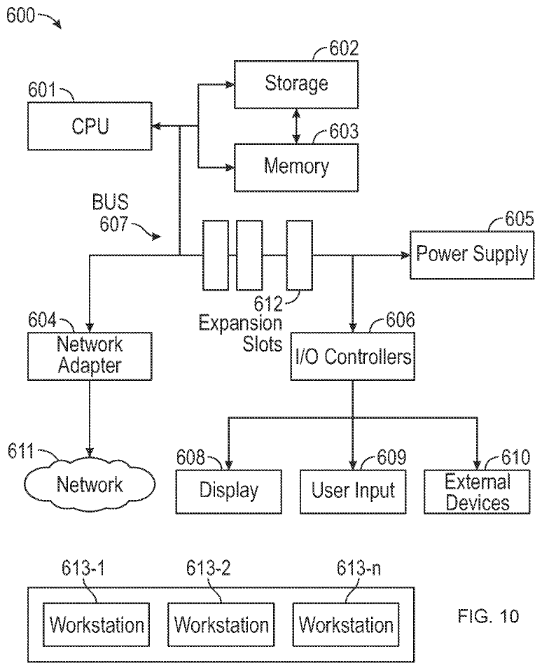

FIG. 10 illustrates an exemplary computing system or electronic device for implementing the examples of the disclosure. System 1000 may include, but is not limited to known components such as central processing unit (CPU) 1001, storage 1002, memory 1003, network adapter 1004, power supply 1005, input/output (I/O) controllers 1006, electrical bus 1007, one or more displays 1008, one or more user input devices 1009, and other external devices 1010. It will be understood by those skilled in the art that system 1000 may contain other well-known components which may be added, for example, via expansion slots 712, or by any other method known to those skilled in the art. Such components may include, but are not limited, to hardware redundancy components (e.g., dual power supplies or data backup units), cooling components (e.g., fans or water-based cooling systems), additional memory and processing hardware, and the like.

System 1000 may be, for example, in the form of a client-server computer capable of connecting to and/or facilitating the operation of a plurality of workstations or similar computer systems over a network. In another embodiment, system 1000 may connect to one or more workstations over an intranet or internet network, and thus facilitate communication with a larger number of workstations or similar computer systems. Even further, system 1000 may include, for example, a main workstation or main general-purpose computer to permit a user to interact directly with a central server. Alternatively, the user may interact with system 1000 via one or more remote or local workstations 1013. As will be appreciated by one of ordinary skill in the art, there may be any practical number of remote workstations for communicating with system 1000.

CPU 1001 may include one or more processors, for example Intel® Core™ G7 processors, AMD FX™ Series processors, or other processors as will be understood by those skilled in the art (e.g., including graphical processing unit (GPU)-style specialized computing hardware used for, among other things, machine learning applications, such as training and/or running the machine learning algorithms of the disclosure; such GPUs may include, e.g., NVIDIA Tesla™ K80 processors). CPU 1001 may further communicate with an operating system, such as Windows NT® operating system by Microsoft Corporation, Linux operating system, or a Unix-like operating system. However, one of ordinary skill in the art will appreciate that similar operating systems may also be utilized. Storage 1002 (e.g., non-transitory computer readable medium) may include one or more types of storage, as is known to one of ordinary skill in the art, such as a hard disk drive (HDD), solid state drive (SSD), hybrid drives, and the like. In one example, storage 1002 is utilized to persistently retain data for long-term storage. Memory 1003 (e.g., non-transitory computer readable medium) may include one or more types of memory as is known to one of ordinary skill in the art, such as random access memory (RAM), read-only memory (ROM), hard disk or tape, optical memory, or removable hard disk drive. Memory 1003 may be utilized for short-term memory access, such as, for example, loading software applications or handling temporary system processes.

As will be appreciated by one of ordinary skill in the art, storage 1002 and/or memory 1003 may store one or more computer software programs. Such computer software programs may include logic, code, and/or other instructions to enable processor 1001 to perform the tasks, operations, and other functions as described herein (e.g., the stochastic modeling, AI engine, data disaggregation, compilation of one or more AI training set described herein), and additional tasks and functions as would be appreciated by one of ordinary skill in the art.

Operating system 1002 may further function in cooperation with firmware, as is well known in the art, to enable processor 1001 to coordinate and execute various functions and computer software programs as described herein. Such firmware may reside within storage 1002 and/or memory 1003.

Moreover, I/O controllers 1006 may include one or more devices for receiving, transmitting, processing, and/or interpreting information from an external source, as is known by one of ordinary skill in the art. In one embodiment, I/O controllers 1006 may include functionality to facilitate connection to one or more user devices 1009, such as one or more keyboards, mice, microphones, trackpads, touchpads, or the like. For example, I/O controllers 1006 may include a serial bus controller, universal serial bus (USB) controller, FireWire controller, and the like, for connection to any appropriate user device. I/O controllers 1006 may also permit communication with one or more wireless devices via technology such as, for example, near-field communication (NFC) or Bluetooth™. In one embodiment, I/O controllers 1006 may include circuitry or other functionality for connection to other external devices 1010 such as modem cards, network interface cards, sound cards, printing devices, external display devices, or the like. Furthermore, I/O controllers 1006 may include controllers for a variety of display devices 1008 known to those of ordinary skill in the art. Such display devices may convey information visually to a user or users in the form of pixels, and such pixels may be logically arranged on a display device in order to permit a user to perceive information rendered on the display device. Such display devices may be in the form of a touch screen device, traditional non-touch screen display device, or any other form of display device as will be appreciated be one of ordinary skill in the art.

Furthermore, CPU 1001 may further communicate with I/O controllers 1006 for rendering a graphical user interface (GUI) on, for example, one or more display devices 1008. In one example, CPU 1001 may access storage 1002 and/or memory 1003 to execute one or more software programs and/or components to allow a user to interact with the system as described herein. In one embodiment, a GUI as described herein includes one or more icons or other graphical elements with which a user may interact and perform various functions. For example, GUI 1007 may be displayed on a touch screen display device 1008, whereby the user interacts with the GUI via the touch screen by physically contacting the screen with, for example, the user's fingers. As another example, GUI may be displayed on a traditional non-touch display, whereby the user interacts with the GUI via keyboard, mouse, and other conventional I/O components 1009. GUI may reside in storage 1002 and/or memory 1003, at least in part as a set of software instructions, as will be appreciated by one of ordinary skill in the art. Moreover, the GUI is not limited to the methods of interaction as described above, as one of ordinary skill in the art may appreciate any variety of means for interacting with a GUI, such as voice-based or other disability-based methods of interaction with a computing system.

Moreover, network adapter 1004 may permit device 1000 to communicate with network 1011. Network adapter 1004 may be a network interface controller, such as a network adapter, network interface card, LAN adapter, or the like. As will be appreciated by one of ordinary skill in the art, network adapter 1004 may permit communication with one or more networks 1011, such as, for example, a local area network (LAN), metropolitan area network (MAN), wide area network (WAN), cloud network (IAN), or the Internet.

One or more workstations 1013 may include, for example, known components such as a CPU, storage, memory, network adapter, power supply, I/O controllers, electrical bus, one or more displays, one or more user input devices, and other external devices. Such components may be the same, similar, or comparable to those described with respect to system 1000 above. It will be understood by those skilled in the art that one or more workstations 1013 may contain other well-known components, including but not limited to hardware redundancy components, cooling components, additional memory/processing hardware, and the like.

The preceding description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

1. A system comprising:
an artificial intelligence/machine learning (AI) model or engine adapted to be used as a mechanism for achieving predictive analytics from as-yet unknown adverse future events against one or a plurality of items, wherein the AI model is adapted to evaluate a plurality of known factors for one or a set of evaluation items,
wherein the artificial intelligence/machine learning (AI) model is adapted to use AI to:
build an AI training set based on aggregate data to narrow down a plurality of clusters from the aggregate data,
use AI on individual items in each cluster,
compare the output across clusters to find one or more ranked elements; and
identify individual items through the characteristics to provide the training set, and
wherein the training set is used to evaluate and identify all items across an entire data set resulting in a score or other metric which predicts the likelihood of an adverse or positive future impact for each individual item.

2. The system of claim 1, wherein the AI model is adapted to identify a set of items with known outcomes from various events, optionally historical events and item characteristics, to provide an artificial intelligence training set.

3. The system of claim 2, wherein the training comprises identified likelihood of a potential event from various item characteristics.

4. The system of claim 3, wherein further evaluations of items in clusters is performed to identify item features or characteristics that drive the likelihood of a potential event affecting individual items.

5. The system of claim 2, wherein simulations are processed against the training set using a plurality of known attributes or features for each item.

6. The system of claim 5, wherein a derived set of attributes is generated, the attributes more or less likely to result in damage, without a developer feeding such parameters to the model.

7. The system of claim 1, wherein the AI model is trained on a training data set along with a set of identifiable features or attributes of each item in the training set and used to predict a likelihood of an event occurrence on new items fed to the model.

8. The system of claim 7 wherein the new items are previously unknown to the model.

9. The system of claims 7 or 8, wherein the identified set of features or attributes learned from the training set is applied to the new items.

10. The system of claim 9, wherein features or attributes of the new items are used by the AI model to predict the likelihood of an event occurrence or lack thereof based on the AI model prior training.

11. A system comprising:
a plurality of stochastic probabilistic models each developed from a set of historical events, wherein each such event has a footprint that has previously occurred or is predicted to occur, wherein the stochastic probabilistic model is adapted to simulate a plurality of actual or simulated events against a plurality of items; and
an artificial intelligence/machine learning (AI) model or engine adapted to be used as an alternate mechanism for achieving predictive analytics from as-yet unknown adverse future events against one or a plurality of items, wherein the AI model is adapted to evaluate a plurality of known factors for one or a set of evaluation items,
wherein the artificial intelligence/machine learning (AI) model is adapted to use AI to build an AI training set based aggregate data to narrow down a plurality of clusters from the aggregate data, use AI on individual items in each cluster, compare the output across clusters to find one or more ranked elements; and identify individual items through the characteristics to provide the training set,
wherein the training set is used to evaluate and identify all items across an entire data set resulting in a score or other metric which predicts the likelihood of an adverse or positive future impact for each individual item,
wherein the score or metric is used to weight each stochastic probabilistic model to adjust its prediction accordingly based on the score.

12. The system of claim 11, wherein the combination of the stochastic probabilistic model and the AI model is adapted to provide predictive analytics from events to the one or the set of evaluation items yielding improved output and interpretation versus either method in isolation.

13. The system of claim 11, wherein the footprint comprises a geographic footprint, a demographic footprint, or a class footprint.

14. The system of claim 11, wherein the historical event footprint comprises a cataloged and detailed set of forces and probable impacts to items in a set submitted to the model.

15. The system of claim 14, wherein the set of forces are translated into a severity, indicating the likelihood of adverse damage from the forces to items affected by the event footprint.

16. The system of claim 15, wherein an amount of adverse damage to specific items in the historical event are known, along with a plurality of various attributes pertaining to those items.

17. The system of any of the preceding claims, wherein the historic event footprints and their damage impacts are used to create an event catalog, or stochastic collection of events based on a plurality of data inputs.

18. The system of any of the preceding claims, wherein an event catalog is organized by a set of simulation periods, each simulation period containing one or a plurality of events from the catalog.

19. The system of claim 18, wherein organization by the set of simulation period is adapted to allow each such simulation period to be run against one or more items submitted to the model for assessment.

20. The system of claim 19, wherein each simulation period is used in a sampling process.

21. The system of any of claims 17-20, wherein the number of simulation periods is fed into analytics statistics to forecast the probability or likelihood of damage to the single or plurality of items.

22. The system of claim 21, wherein an output from the stochastic probabilistic model comprises a probability of a damage estimated.

23. The system of claim 11, wherein the AI model is adapted to identify a set of items with known outcomes from various events, optionally historical events and item characteristics, to provide an artificial intelligence training set.

24. The system of claim 23, wherein the training comprises identified likelihood of a potential event from various item characteristics.

25. The system of claim 24, wherein further evaluations of items in clusters is performed to identify item features or characteristics that drive the likelihood of a potential event affecting individual items.

26. The system of claim 23, wherein simulations are processed against the training set using a plurality of known attributes or features for each item.

27. The system of claim 26, wherein a derived set of attributes is generated, the attributes more or less likely to result in damage, without a model developer feeding such parameters to the model.

28. The system of claim 11, wherein the AI model is trained on a training data set along with a set of identifiable features or attributes of each item in the training set and used to predict a likelihood of an event occurrence on new items fed to the model.

29. The system of claim 28 wherein the new items are previously unknown to the model.

30. The system of claims 28 or 29, wherein the identified set of features or attributes learned from the training set is applied to the new items.

31. The system of claim 20, wherein features or attributes of the new items are used by the AI model to predict the likelihood of an event occurrence or lack thereof based on the AI model prior training.

32. A method or system for discretization of aggregate data comprising:
using AI to build an AI training set based on gross characters to narrow down clusters;
using AI on individual items in each cluster (positive and negative clusters);
comparing the output across clusters to find the ranked elements that drive a positive or negative result; and
identifying individual items through the characteristics which comprises the training set.

33. The method of claim 32, wherein a score is derived from feature and/or attribute weighting.

34. The method of claim 33, wherein individual items are scored based on a training set and identified features.

35. The system of claim 1, wherein the AI model or engine is processed across a plurality of parallel processes operating on a plurality of processors or cores.

36. The system of claim 35, wherein individual clusters of the plurality clusters are processed using different processors or cores of the plurality of processors or cores.

37. A method comprising:
using an artificial intelligence/machine learning (AI) model or engine as a mechanism for achieving predictive analytics from as-yet unknown adverse future events against one or a plurality of items, wherein the AI model is adapted to evaluate a plurality of known factors for one or a set of evaluation items,
using the artificial intelligence/machine learning (AI) model AI to:
build an AI training set based on aggregate data to narrow down a plurality of clusters from the aggregate data,
use AI on individual items in each cluster,
compare the output across clusters to find one or more ranked elements, and
identify individual items through the characteristics to provide the training set; and
wherein the training set is used to evaluate and identify all items across an entire data set resulting in a score or other metric which predicts the likelihood of an adverse or positive future impact for each individual item.

38. The method of claim 37, wherein the AI model is adapted to identify a set of items with known outcomes from various events, optionally historical events and item characteristics, to provide an artificial intelligence training set.

39. The method of claim 38, wherein the training comprises identified likelihood of a potential event from various item characteristics.

40. The method of claim 39, wherein further evaluations of items in clusters is performed to identify item features or characteristics that drive the likelihood of a potential event affecting individual items.

41. The method of claim 38, wherein simulations are processed against the training set using a plurality of known attributes or features for each item.

42. The method of claim 41, wherein a derived set of attributes is generated, the attributes more or less likely to result in damage, without a developer feeding such parameters to the model.

43. The method of claim 37, wherein the AI model is trained on a training data set along with a set of identifiable features or attributes of each item in the training set and used to predict a likelihood of an event occurrence on new items fed to the model.

44. The method of claim 43 wherein the new items are previously unknown to the model.

45. The method of claims 43 or 44, wherein the identified set of features or attributes learned from the training set is applied to the new items.

46. The method of claim 45, wherein features or attributes of the new items are used by the AI model to predict the likelihood of an event occurrence or lack thereof based on the AI model prior training.

47. The method of claim 37, wherein the operation of building an AI training set based on aggregate data to narrow down a plurality of clusters from the aggregate data comprises:
identifying clusters within a plurality of regions; and
identifying predictive features within the plurality of regions.

48. The method of claim 47, wherein the identified predictive features are applied to an entire set and predictive scores are generated.

49. The method of claim 48, wherein operations of identifying clusters, identifying predictive features, and applying the identified predictive features to the entire set to generate predictive scores are processed on a plurality of cores of a plurality of servers.

50. A method comprising:
using a plurality of stochastic probabilistic models each developed from a set of historical events, wherein each such event has a footprint that has previously occurred or is predicted to occur, to simulate a plurality of actual or simulated events against a plurality of items; and
using an artificial intelligence/machine learning (AI) model or engine adapted to be used as an alternate mechanism for achieving predictive analytics from as-yet unknown adverse future events against one or a plurality of items, wherein the AI model is adapted to evaluate a plurality of known factors for one or a set of evaluation items,
using the artificial intelligence/machine learning (AI) model to use AI to:
build an AI training set based aggregate data to narrow down a plurality of clusters from the aggregate data,
use AI on individual items in each cluster,
compare the output across clusters to find one or more ranked elements, and
identify individual items through the characteristics to provide the training set; and
wherein the training set is used to evaluate and identify all items across an entire data set resulting in a score or other metric which predicts the likelihood of an adverse or positive future impact for each individual item,
wherein the score or metric is used to weight each stochastic probabilistic model to adjust its prediction accordingly based on the score.

51. The method of claim 50, wherein the combination of the stochastic probabilistic model and the AI model is adapted to provide predictive analytics from events to the one or the set of evaluation items yielding improved output and interpretation versus either method in isolation.

52. The method of claim 50, wherein the footprint comprises a geographic footprint, a demographic footprint, or a class footprint.

53. The method of claim 50, wherein the historical event footprint comprises a cataloged and detailed set of forces and probable impacts to items in a set submitted to the model.

54. The method of claim 53, wherein the set of forces are translated into a severity, indicating the likelihood of adverse damage from the forces to items affected by the event footprint.

55. The method of claim 54, wherein an amount of adverse damage to specific items in the historical event are known, along with a plurality of various attributes pertaining to those items.

56. The method of any of the preceding claims, wherein the historic event footprints and their damage impacts are used to create an event catalog, or stochastic collection of events based on a plurality of data inputs.

57. The method of any of the preceding claims, wherein an event catalog is organized by a set of simulation periods, each simulation period containing one or a plurality of events from the catalog.

58. The method of claim 57, wherein organization by the set of simulation period is adapted to allow each such simulation period to be run against one or more items submitted to the model for assessment.

59. The method of claim 58, wherein each simulation period is used in a sampling process.

60. The method of any of claims 56-59, wherein the number of simulation periods is fed into analytics statistics to forecast the probability or likelihood of damage to the single or plurality of items.

61. The method of claim 60, wherein an output from the stochastic probabilistic model comprises a probability of a damage estimated.
